(19) United States
(12) Patent Application Publication
(10) Pub. No.: US 2008/0166508 A1
(43) Pub. Date: Jul. 10, 2008

(54) Structure made of foamed material

(76) Inventor: Christopher M. Edwards, Midland, MI (US)

Correspondence Address: Timothy S. Stevens, Patent Attorney, 5108 Foxpoint Circle, Midland, MI, 48642, US

(21) Appl. No.: 12/006,454

(22) Filed: Jan. 2, 2008

Related U.S. Application Data
(60) Provisional application No. 60/878,262, filed on Jan. 3, 2007.

(51) Int. Cl. B32B 15/095; B32B 9/00; B32B 27/40; B32B 3/26; B29C 53/02; B32B 15/08; B32B 27/00

(52) U.S. Cl. 428/34.1; 428/411.1; 428/423.1; 428/422.8; 428/457; 428/304.4; 264/339

(57) ABSTRACT

A structure consisting of a sheet of foamed material having a first side and a second side, at least one sheet of reinforcing material having a first side and a second side, the first side of the sheet of reinforcing material being attached to the first side of the sheet of foamed material, the tensile strength and stiffness of the sheet of reinforcing material being greater parallel to the plane of the sheet of reinforcing material than the compressive strength and stiffness of the sheet of foamed material parallel to the plane of the sheet of foamed material, the structure being deformed so that the second side of the sheet of reinforcing material is in tension and the second side of the sheet of foamed material is in compression. A method consisting of the step of bending such a structure so that the second side of the sheet of reinforcing material is in tension and the second side of the sheet of foamed material is in compression.

### BACKGROUND OF THE INVENTION

The instant invention is in the field of structures comprising a sheet of a foamed material, such as sheet of low density foamed polymer, wherein the sheet of foamed material has been deformed or bent. The instant invention also is in the field of deforming or bending a sheet of a foamed material without breaking the sheet of foamed material.

Low density polymeric foams are used for many applications including thermal insulation, noise insulation, energy absorption, draft prevention, cores in sandwich panels, buoyancy and space filling. Polymeric foam materials include foamed polystyrene (PS), polyethylene (PE), polypropylene (PP), polyurethanes (PU), styrene acrylonitrile (SAN), polyvinylchloride (PVC) and polyethylene teraphthalate (PET).

One very economical method of polymer foam manufacture is to extrude the foam as sheets or slabs of constant thickness. These are often further sliced to produce thinner sheets. Such sheets are widely used and are relatively inexpensive. However, sheets of foamed polymer tend to break when deformed or bent. In general foams are quite resilient in compression but have little capability to withstand tensile elongation. As a result if it is attempted to bend such a sheet (which causes one face of the sheet to be placed in tension and the other face of the sheet in compression) the sheet breaks on the tension side. This phenomenon reduces the utility of foam sheets in, for example, applications where it is desired to curve or bend the sheet. In particular, rigid foamed polymer sheets such as polystyrene, SAN, PVC and PET foam are very difficult to bend or deform to any useful degree.

If it were possible to easily bend sheets of rigid foamed materials into two or three dimensional shapes it would greatly enhance their utility in producing, for example, structural shells such as buildings, boxes, boat hulls, truck boxes and the like. It would therefore be extremely beneficial if a method could be developed whereby sheets of foamed materials could be easily bent or deformed without breaking and in particular sheets of low cost rigid foamed polymer such as sheets of foamed polystyrene.

### SUMMARY OF THE INVENTION

The instant invention provides a method whereby sheets of foamed materials can be readily bent or deformed without breaking. More specifically, the instant invention is a structure, comprising: a sheet of foamed material having a first side and a second side, at least one sheet of reinforcing material having a first side and a second side, the first side of the sheet of reinforcing material being attached to the first side of the sheet of foamed material, the tensile strength and stiffness of the sheet of reinforcing material being greater parallel to the plane of the sheet of reinforcing material than the compressive strength and stiffness of the sheet of foamed material parallel to the plane of the sheet of foamed material, the structure being deformed so that the second side of the sheet of reinforcing material is in tension and the second side of the sheet of foamed material is in compression.

In a related embodiment, the instant invention is a method of deforming a structure comprising a sheet of foamed material having a first side and a second side, at least one sheet of reinforcing material having a first side and a second side, the first side of the sheet of reinforcing material being attached to the first side of the sheet of foamed material, the tensile strength and stiffness of the sheet of reinforcing material being greater parallel to the plane of the sheet of reinforcing material than the compressive strength and stiffness of the sheet of foamed material parallel to the plane of the sheet of foamed material, the method comprising the step of deforming the structure so that the second side of the sheet of reinforcing material is in tension and the second side of the sheet of foamed material is in compression.

### BRIEF DESCRIPTION OF THE DRAWINGS

FIG. 1B shows the effect of bending a sheet of the prior art foam material of FIG. 1A;

FIG. 2B shows the effect of bending a sheet of composite foam material of FIG. 2A wherein a rigid skin is bonded to one side of the foam material;

FIG. 3A shows a structure consisting of a foam sheet with a continuous skin bonded to one side and discontinuous skins bonded to the other side.

FIG. 3B shows the shape that the structure of FIG. 3A will assume when a bending moment is applied.

FIG. 4A shows a structure consisting of a foam sheet with a continuous skin bonded to one side and discontinuous skins bonded to the other side, with a large central gap between discontinuous skins;

FIG. 4B shows the shape that such the structure of FIG. 4A will assume when a bending moment is applied;

FIG. 5A shows a structure consisting of a foam sheet with discontinuous skins bonded to each side, with the discontinuities arranged to enable the sheet to be bent as shown in FIG. 5B;

FIG. 6A shows a foam sheet disc with a fishnet mesh bonded to one surface;

FIG. 6B shows the effect of bending the disc of FIG. 6A into a dome or hemispherical shape;

FIG. 6C shows a cross section through the structure of FIG. 6B.

FIG. 6D shows a cross section of the structure of FIG. 6B after additional composite skins have been applied to each side thereof.

FIG. 7A shows a cross section of a structure comprising a sheet of pierced metal foil pressed into a sheet of foamed material to attach the reinforcing sheet to the sheet of foamed material; and

FIG. 7B shows the shape that the structure of FIG. 7A will assume when a bending moment is applied.

### DETAILED DESCRIPTION

When a sheet material of finite thickness is bent the convex side of the sheet is placed in tension and becomes longer while the concave side is placed in compression and becomes shorter. Materials which are ductile in both tension and compression can be bent without breaking. Examples include most metals, many plastics. Materials which are brittle, particularly those which have low tensile elongation, break at low deflections when bent. Examples include glass and concrete. Rigid foams such as foamed SAN, PET, PVC and polystyrene also tend to fail in tension when bent.

If it is attempted to bend such a sheet of rigid foam material then generally the sheet will break in the tension side of the sheet before a significant bend has been achieved. Equally, it is very difficult to bend or form such a sheet into a three-dimensional shape such as the shape of a crash helmet or boat hull without the foam cracking or breaking on the tension side of the sheet. This phenomenon greatly reduces the utility of such sheet materials. When a sandwich panel with a curved core is required, then it is often necessary to segment the core to allow the panel to be shaped resulting in extra cost and extra resin to fill the gaps.

The instant invention provides a means to bend or deform a sheet of foamed material by attaching a reinforcing skin (i.e., a sheet of reinforcing material) to one surface of the foam such that when the foam is bent, the reinforcing skin is placed in tension and the opposing face of the foam, with no skin, is placed in compression so that no significant tension occurs anywhere in the foamed material to cause breakage thereof. The skin attached to the tensile face prevents the foam immediately beneath the skin from being placed in tension so that if the panel is bent all of the mismatch in length between the tension face and compression face is taken up by compressing the foam. The reinforcing skin which is attached to the foam can be any material which is both strong and has significantly higher tensile modulus than the foam itself. Preferably the skin has a tensile modulus greater than 300,000 psi, more preferably greater than 800,000 psi, most preferably greater than 1,000,000 psi. Examples of skins include sheets of thermoplastic, sheets of fiber-reinforced composites, metal sheets, adhesive tape, fiber-reinforced adhesive tape and the like. The foam may be any polymeric foam, preferably a rigid, i.e. non-elastomeric, foam. Examples include extruded or expanded polystyrene, SAN, PET, polyurethane, polyisocyanurate, PVC, polypropylene, polyethylene. The foam structure may be open or closed cell. The foam may also be made from other ductile materials such as metals.

The foam preferably has a compressive strength perpendicular to the plane of the sheet greater than 30 psi. More preferably the foam has a compressive strength perpendicular to the plane of the sheet greater than 50 psi. Most preferably the foam has a compressive strength perpendicular to the plane of the sheet greater than 60 psi and has a lower modulus in the direction within the plane of the sheet than perpendicular to it. A preferred foam structure is one in which the foam stiffness in the plane of the sheet is less than the stiffness perpendicular to the plane of the sheet. An example of such foam is Impaxx polystyrene foam, commercially available from The Dow Chemical Company. An EVA based adhesive is preferred for bonding the sheet of reinforcing material to a sheet of polystyrene foam.

The bent sheet of foam with a reinforcing skin attached to one surface can be used to produce a curved, rigid, tent-like structure for use as a shelter for temporary or emergency use. The advantages of such a structure are that it can be transported as flat sheets which are bent into an arched shape on site, saving space for transport. It is very light weight and it has excellent insulation provided by the foam.

The reinforcing skin may be a double sided adhesive tape. The adhesive on one side of the tape is used to bond the tape to the foam, while the adhesive on the other side of the tape may be used to bond the bent foam to another component. In this embodiment the foam may be impact absorption components, for example for an automobile which may be bent to fit into a roof liner, around a door pillar or into the shape of a knee bolster. Also the foam may be insulation which, by bending and bonding may be made to fit into corner spaces. Further this embodiment may be used as a rapid and effective means to wrap foam around pipes or pressure vessels as thermal insulation.

A continuous reinforcing skin may be attached to one surface of the foam while a second reinforcing skin is attached to discrete areas of the foam. In this way when a bending load is applied the foam will bend only in the areas where the second reinforcing skin has not been applied and remain straight in the areas where a reinforcing skin has been applied to both sides of the foam. In this way more complex structural shapes can be created. In this embodiment foam panels can be used to produce house like shapes in order to construct buildings with integral walls and roofs. Similarly the foam may be bent to form the sides of a box, to produce packaging containers, truck boxes and other flat sided structures. Further the reinforcing skins may be made discontinuous on both sides of the foam sheet in order to facilitate the sheet being bent in both directions provided that the sheet is bent to maintain the area of foam lacking a reinforcing skin in compression.

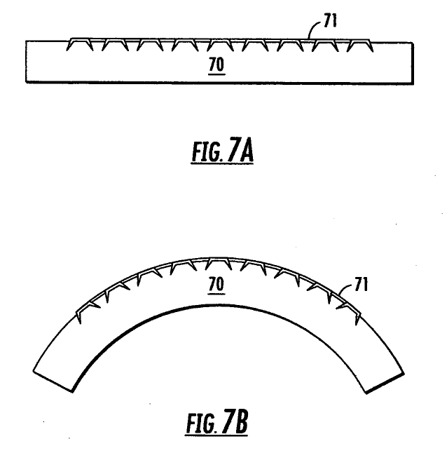

The sheet of reinforcing material can have protuberances which protuberances embed into the sheet of foamed material. The protuberances ensure that the sheet of reinforcing material and the sheet of foamed material are held together in a way that prevents sliding between them as they are bent. In this way, the sheet of reinforcing material prevents tension from being applied to the foam in the same way as when a sheet of reinforcing material is bonded to the surface of the foam. An example of such a sheet of reinforcing material is a pierced metal foil where the piercing causes spikes of material to be pushed perpendicular to the plane of the sheet of foamed material as shown in FIG. 7. An example of pierced metal foil is sold commercially by Diamond Manufacturing Company under the trade name PLASTICORE. The use of such a sheet of reinforcing material provides a means to create bent foam without permanently bonding the reinforcing material to the sheet of foamed material. Once the foam has been bent, the sheet of reinforcing material can be removed and if desired flattened and reused. This method of bending a sheet of foamed material that is particularly useful in producing shaped foam blocks which would otherwise have to be produced by cutting the shapes from a solid slab. Bending the shapes from sheet instead of cutting from slab can dramatically reduce waste. An example of the application of such shaped foam pieces is the energy absorbing structures placed with automobiles to protect passengers during crashes. These structures typically have relatively complex shapes to fit within the available shape of the car body. When these shapes are cut from a foam block considerable wastage results. If the shapes are produced by bending flat pieces the wasted foam is dramatically reduced.

The reinforcing skin may be a perforated sheet of material or a layer of material with holes or cut outs. Examples include woven cloth, fabric, metal sheets containing holes, scrim and honeycomb. The particular advantage of such open reinforcing layers is that they may be readily deformed into three dimensional shapes. The reinforcing layer may again be bonded to the surface of the foam or may additionally be pressed into the surface of the foam and bonded. In this way the foam can be used to produce three dimensional structures such as safety helmets, boat hulls, car body panels, body armor and furniture.

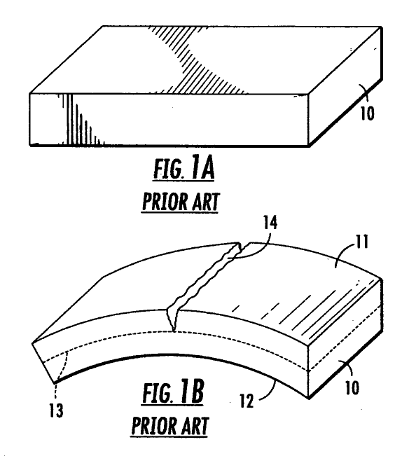

Referring now to FIGS. 1A and 1B, therein is shown the effect of bending a sheet of prior art foam material 10. One surface 11 is placed in tension and elongates while the opposing surface 12 is placed in compression and shortens. Within the sheet there exists a plane known as the neutral axis 13 which remains the same length. Materials which are weak in tension or brittle tend to break as a result is a crack 14 propagating from the face which is in tension.

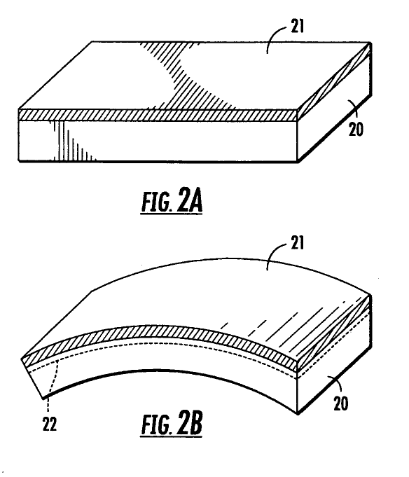

Referring now to FIGS. 2A and 2B, therein is shown the effect of bonding a more rigid skin 21 to the surface of a foamed material 20 and then bending the combined structure with the more rigid skin 21 on the tension side. The neutral axis 22 (that plane within the sheet which does not change in length when the sheet is bent) is moved from the center of the sheet to a position much closer to the more rigid skin. Depending on the relative properties it may be moved entirely to the interface between the skin 21 and the foamed material 20. If the neutral axis is moved to said interface, then the whole thickness of the foamed material 20 is placed in compression when the structure 20/21 is bent.

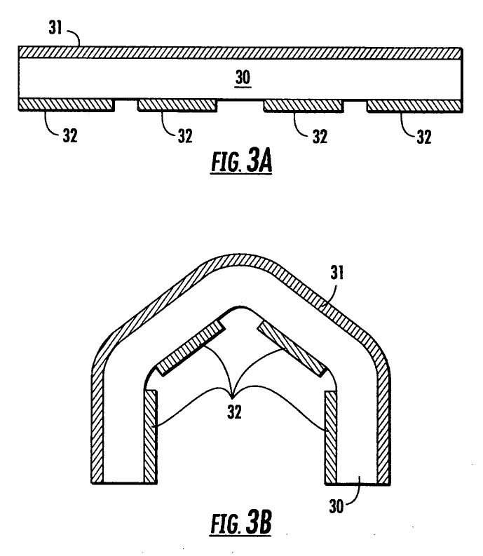

Referring now to FIGS. 3A and 3B, therein is shown a structure consisting of a sheet of foamed material 30 with a continuous skin 31 bonded to one side and discontinuous skins 32 bonded to the other side. FIG. 3B shows the shape that such a structure will deform to when a bending moment is applied. The structure 30/31/32 bends only in those areas where the discontinuous skins 32 are not present and remains straight in those areas where the skins 31 and 32 are present, thus forming a ‘house shape’ with straight walls and curved corners between the walls and roof and at the apex of the roof.

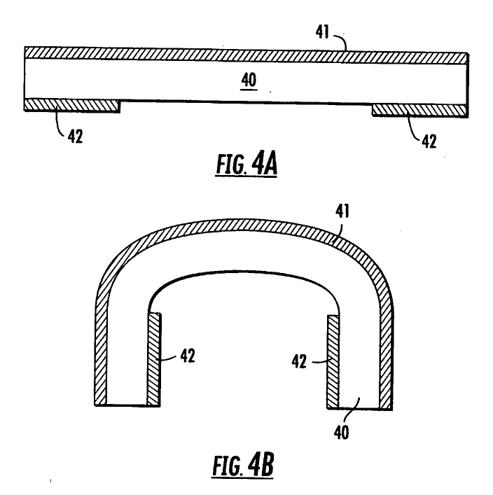

Referring now to FIGS. 4A and 4B, therein is shown a structure consisting of a sheet of foamed material 40 with a continuous skin 41 bonded to one side and discontinuous skins 42 bonded to the other side, with a large central gap between the discontinuous skins. FIG. 4B shows the shape that such a structure 40/41/42 will deform to when a bending moment is applied. The structure 40/41/42 bends only in the central area where the discontinuous skins 42 are not present and remains straight in those areas where the skins 41 and 42 are present, thus forming an ‘arched shape’ with straight walls and an arched domed roof.

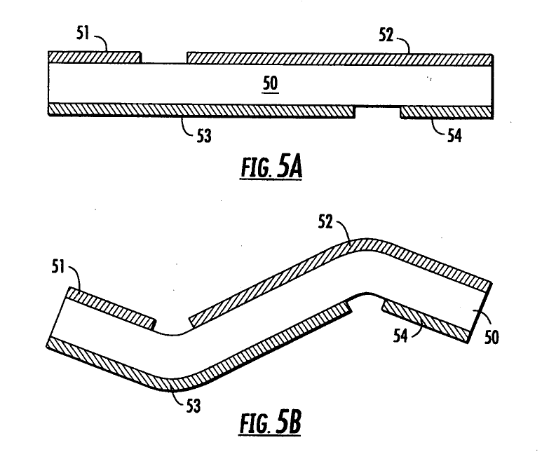

Referring now to FIGS. 5A and 5B, therein is shown a structure consisting of a sheet of foamed material 50 with discontinuous skins 51, 52, 53, and 54 bonded to each side as shown. FIG. 5B shows the shape that such a structure 50/51/52/53/54 will deform to when a bending moment is applied according to the instant invention.

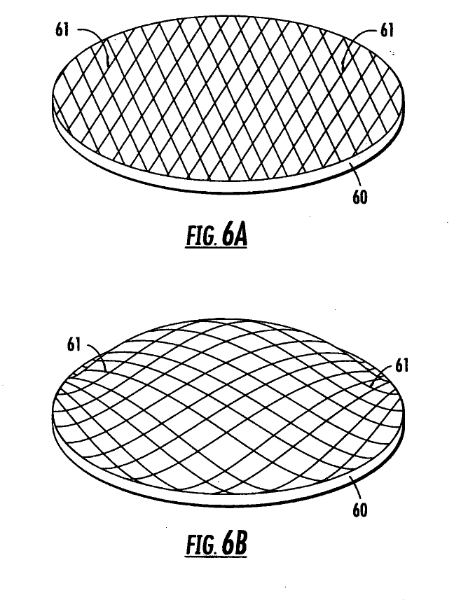

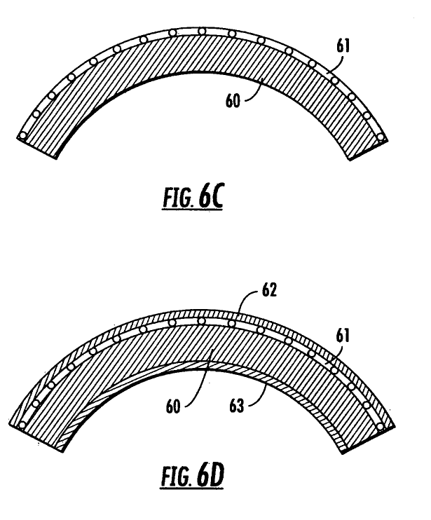

Referring now to FIGS. 6A, 6B and 6C, therein is shown a disk of foamed material 60 having a fish net mesh 61 bonded to one surface thereof. FIG. 6B shows the effect of bending the structure 60/61 into a dome or hemispherical shape either by applying a bending moment around the periphery of the structure 60/61 or by forcing the structure 60/61 over a male plug mold or into a female dish shaped mold. FIG. 6C shows a cross sectional view of the structure 60/61.

Referring now to FIG. 6D, therein is shown a cross sectional view of the structure 60/61 of FIG. 6C after additional composites skins 62 and 63 have been applied.

Referring now to FIGS. 7A and 7B, therein is shown a cross sectional view of a structure comprising a reinforcing sheet of pierced metal foil 71 pressed into a sheet of foamed material 70. FIG. 7B shows the shape that such a structure 70/71 will deform to when a bending moment is applied according to the instant invention.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

What is claimed is:

1. A structure, comprising: a sheet of foamed material having a first side and a second side, at least one sheet of reinforcing material having a first side and a second side, the first side of the sheet of reinforcing material being attached to the first side of the sheet of foamed material, the tensile strength and stiffness of the sheet of reinforcing material being greater parallel to the plane of the sheet of reinforcing material than the compressive strength and stiffness of the sheet of foamed material parallel to the plane of the sheet of foamed material, the structure being deformed so that the second side of the sheet of reinforcing material is in tension and the second side of the sheet of foamed material is in compression.

2. The structure of claim 1, wherein the foamed material is selected from the group comprising foamed polystyrene, foamed SAN, foamed PET, foamed polyurethane, foamed polyisocyanurate, foamed PVC, foamed polypropylene, foamed polyethylene and foamed metal.

3. The structure of claim 2, wherein the sheet of reinforcing material is selected from the group consisting of metal, fiber reinforced composite sheet, extruded thermoplastic sheet, cloth, high pressure laminate, woven natural fiber, woven synthetic fiber, woven ceramic fiber, woven metal wire, metal, perforated metal, perforated metal, scrim, thermoplastic polymer, thermoset polymer, thermoplastic polymer and wood.

4. The structure of claim 1, wherein the compressive strength of the foamed material is greater than thirty pounds per square inch perpendicular to the plane of the sheet.

5. The structure of claim 1, wherein the compressive strength of the foamed material is greater than fifty pounds per square inch perpendicular to the plane of the sheet.

6. The structure of claim 1, wherein the compressive strength of the foamed material perpendicular to the plane of the sheet of foamed material is greater than sixty pounds per square inch and the compressive strength in any direction parallel to the plane of the sheet of foamed material is lower than the compressive strength perpendicular to the plane of the sheet of foamed material.

7. The structure of claim 1, wherein the tensile modulus of the sheet of reinforcing material is greater than two hundred thousand pounds per square inch.

8. The structure of claim 1, wherein the tensile modulus of the sheet of reinforcing material is greater than five hundred thousand pounds per square inch.

9. The structure of claim 1, wherein the tensile modulus of the sheet of reinforcing material is greater than one million pounds per square inch.

10. The structure of claim 1, wherein the structure is a building, a shelter, a house or a component thereof.

11. The structure of claim 1, wherein the structure is an internal or external component of a vehicle.

12. The structure of claim 1, wherein the structure is insulation for a pipe or a vessel.

13. The structure of claim 1, wherein the structure is a box, a container or a component thereof.

14. The structure of claim 1, wherein the structure is a helmet, a boat a hull, body armor, furniture or a component thereof.

15. The structure of claim 1, wherein the structure is a concrete form or a component thereof.

16. A method of deforming a structure comprising a sheet of foamed material having a first side and a second side, at least one sheet of reinforcing material having a first side and a second side, the first side of the sheet of reinforcing material being attached to the first side of the sheet of foamed material, the tensile strength and stiffness of the sheet of reinforcing material being greater parallel to the plane of the sheet of reinforcing material than the compressive strength and stiffness of the sheet of foamed material parallel to the plane of the sheet of foamed material, the method comprising the step of deforming the structure so that the second side of the sheet of reinforcing material is in tension and the second side of the sheet of foamed material is in compression.

17. The method of claim 16, wherein the foamed material is selected from the group comprising foamed polystyrene, foamed SAN, foamed PET, foamed polyurethane, foamed polyisocyanurate, foamed PVC, foamed polypropylene, foamed polyethylene and foamed metal.

18. The method of claim 17, wherein the sheet of reinforcing material is selected from the group consisting of metal, fiber reinforced composite sheet, extruded thermoplastic sheet, cloth, high pressure laminate, woven natural fiber, woven synthetic fiber, woven ceramic fiber, woven metal wire, metal, perforated metal, pierced metal, scrim, thermoplastic polymer, thermoset polymer, thermoplastic polymer and wood.

19. The method of claim 16, wherein the compressive strength of the foamed material is greater than fifty pounds per square inch.

20. The method of claim 16, wherein the compressive strength of the foamed material perpendicular to the plane of the sheet of foamed material is greater than sixty pounds per square inch and the compressive strength in any direction parallel to the plane of the sheet of foamed material is lower than the compressive strength perpendicular to the plane of the sheet of foamed material.
